(19) United States
(12) Patent Application Publication
(10) Pub. No.: US 2004/0108641 A1
(43) Pub. Date: Jun. 10, 2004

(54) Substrate holder

(76) Inventors: Steven A. Reese, Shoreline, WA (US); Peter C. Lombrozo, Aptos, CA (US); James A. Roecker, Bellvue, WA (US); Paul C. Goodwin, Shoreline, WA (US)

Correspondence Address: Pillsbury Winthrop LLP, Intellectual Property Group, Suite 200, 11682 El Camino Real., San Diego, CA, 92130-2092, US

(21) Appl. No.: 10/656,002

(22) Filed: Sep. 5, 2003

Related U.S. Application Data
(60) Provisional application No. 60/408,804, filed on Sep. 6, 2002.

(51) Int. Cl. B23Q 1/64

(52) U.S. Cl. 269/56

(57) ABSTRACT

A system and method of selectively fastening a substrate to a limited travel staging system are disclosed. In accordance with one aspect of a substrate holder, a securing mechanism may be manually or automatically moved in a repeatable manner such that a selected region of a substrate can be moved into the precision travel range of a highly accurate staging system. Some embodiments of a substrate holder may comprise an indexing system enabling referenced movements such that one or more selected substrate regions may be moved relative to the stage.

The present application claims the benefit of U.S. provisional application Serial No. 60/408,804, filed Sep. 6, 2002, entitled “SUBSTRATE HOLDER.”

### FIELD OF THE INVENTION

Aspects of the present invention relate generally to precision actuators, and more particularly to an apparatus, system, and method of precisely positioning a substrate relative to a viewable area on a stage.

### DESCRIPTION OF THE RELATED ART

In mechanical systems, there is generally a compromise between the length of travel of an actuator and the precision with which that actuator can move. For example, in a stage system configured and operative for use in conjunction with a microscope, the precision with which a stage can be positioned generally deteriorates as travel range is extended. On the other hand, high precision stages are known for short travel ranges; one such staging system has been illustrated and described in U.S. Pat. No. 5,812,310, for example. In the disclosed system, travel of the stage is limited to approximately 25 mm. Stage precision (on the order of approximately 100 nm over the full travel of the stage) is generally facilitated by limiting travel as set forth in the above-mentioned patent.

Those of skill in the art will appreciate, however, that such a limit on travel overly constrains the microscope system in certain situations. In fact, in many cases, a scientist or other microscope operator only needs 25 mm of travel, but does not know in advance which 25 mm are needed, i.e., which 25 mm of a particular substrate contain information or objects sought to be observed.

### SUMMARY

Embodiments of the present invention overcome the above-mentioned and various other shortcomings of conventional technology, providing a system and method of selectively fastening a substrate to a limited travel staging system. In accordance with one aspect of the substrate holder as set forth in the present disclosure, a securing mechanism may be manually or automatically moved in a repeatable manner such that a selected region of a substrate can be moved into the precision travel range (or region of travel) of a highly accurate staging system.

In accordance with one aspect, a substrate holder generally comprises a fixed portion configured and operative to be attached to a precision stage, a movable portion operably coupled to the fixed portion and selectively movable relative thereto, a securing mechanism configured and operative to secure a substrate at a predetermined location relative to the movable portion, and an actuator mechanism operative to provide movement of the movable portion relative to the fixed portion.

In some embodiments, the fixed portion may be integrated with the precision stage; alternatively, the fixed portion may be adjustably attached to the precision stage, allowing its fixed position to be selectively altered. The movable portion may be movable in one or two dimensions relative to the fixed portion. Additionally, each of the fixed portion and the movable portion may generally comprise a respective aperture cooperating to form a window in the holder; in such an embodiment, the securing mechanism may be operative to secure the substrate at a particular location relative to the window.

The securing mechanism may be embodied in a spring clip operative to bias the substrate against one or more structures attached or disposed on the movable portion at one or more suitable locations. The securing mechanism may alternatively comprise a different type of biasing element such as a set screw. In some simplified embodiments, the securing structure may comprise a post dimensioned to engage a bore in the substrate.

The actuator mechanism may comprise a rack and pinion, worm gear, ball screw, or similar system. In some embodiments, a substrate holder may comprise a first and a second actuator mechanism, wherein the first actuator mechanism is operative to provide movement of the movable portion in a first dimension and the second actuator mechanism is operative to provide movement of the movable portion in a second dimension.

Additionally, a substrate holder as set forth herein may comprise an indexed reference system. The reference system may include one or more reference indicia, each of which may be associated with a particular area of the substrate. In accordance with some embodiments, a reference indicum may be aligned with a pointer and provide an indication that the associated substrate area is located within the precision travel range of the stage.

A precision travel staging system may comprise a precision stage and a substrate holder substantially as set forth herein. In that regard, a system may comprise, inter alia, a precision stage, a fixed portion of a substrate holder configured and operative to be attached to the precision stage, a movable portion of the substrate holder operably coupled to the fixed portion and selectively movable relative thereto, a securing mechanism configured and operative to secure a substrate at a predetermined location relative to the movable portion, and an actuator mechanism operative to provide movement of the movable portion relative to the fixed portion. The various modifications and alternatives set forth above with reference to the substrate holder may also have applications in a precision travel staging system.

In accordance with another aspect of the present invention, a method of selectively fastening a substrate to a limited travel staging system may generally comprise attaching a fixed portion of a substrate holder to a precision stage, coupling a movable portion of the substrate holder to the fixed portion, and securing a substrate in a predetermined position relative to the movable portion.

Where the fixed portion of the substrate holder is incorporated or integrated with the precision stage, the movable portion noted above may be coupled to the stage itself. The securing may comprise utilizing a spring, a set screw, or other suitable biasing element.

In some embodiments, the foregoing method may additionally comprise indexing the substrate holder such that a particular area of the substrate is associated with a corresponding indicum on an index. In methods employing an index system, selectively moving the associated area of the substrate within the precision travel range of the stage may generally comprise translating the movable portion relative to the fixed portion such that an indicum corresponding to the selected substrate area is aligned with a pointer.

The foregoing and other aspects of various embodiments of the present invention will be apparent through examination of the following detailed description thereof in conjunction with the accompanying drawings.

### BRIEF DESCRIPTION OF THE DRAWINGS

FIG. 1 is a simplified block diagram illustrating the precision travel range of a stage relative to the size of a substrate.

FIG. 2 is a simplified perspective diagram illustrating one embodiment of a substrate holder.

FIG. 3 is a simplified partially exploded diagram illustrating the embodiment of a substrate holder depicted in FIG. 2.

FIG. 4 is a simplified perspective diagram illustrating various embodiments of a securing mechanism.

### DETAILED DESCRIPTION

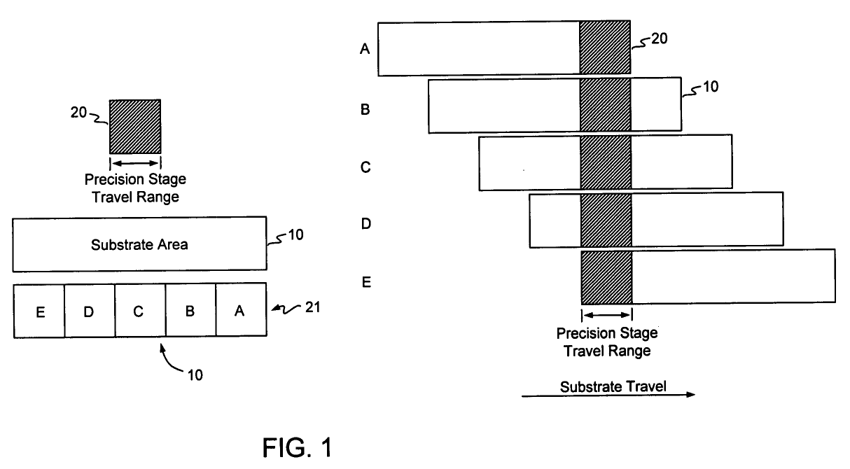

FIG. 1 is a simplified block diagram illustrating the precision travel range of a stage relative to the size of a substrate. In the exemplary FIG. 1 representation, rectangular shapes 10 generally correspond to a plan, or top, view of a substrate such as, for example, a 1″×3″ microscope slide. Hashed square shapes 20 generally represent the travel range of a high-precision stage (not depicted in FIG. 1). In a typical system, precision stage travel range 20 may be appreciably less than the overall substrate area 10. Moving the substrate from position A to position E relative to the stage as depicted in FIG. 1 enables the various areas A-E on the substrate that can be observed with high resolution to be selectively altered in accordance with system requirements. In accordance with some embodiments employing an indexing system as set forth herein, it is possible to switch or toggle easily between one or more selected substrate regions A-E, for example, and to return to a given or selected area of interest.

On the left side of the illustration of FIG. 1, reference numeral 21 depicts the individual areas A-E of the overall substrate area 10 which are viewable when the substrate is located (relative to a movable stage substantially as set forth in detail below) in accordance with the respective positions A through E on the right side of FIG. 1. Whereas FIG. 1 indicates that each area A-E precisely abuts its neighboring area or areas, it will be appreciated that a repeatable substrate holder configured and operative as set forth herein may enable or allow areas A-E to overlap to a desired degree; for example, portions of area B, portions of area D, or both, may be viewable when the substrate is positioned to align area C within the precision travel range 20 of the stage.

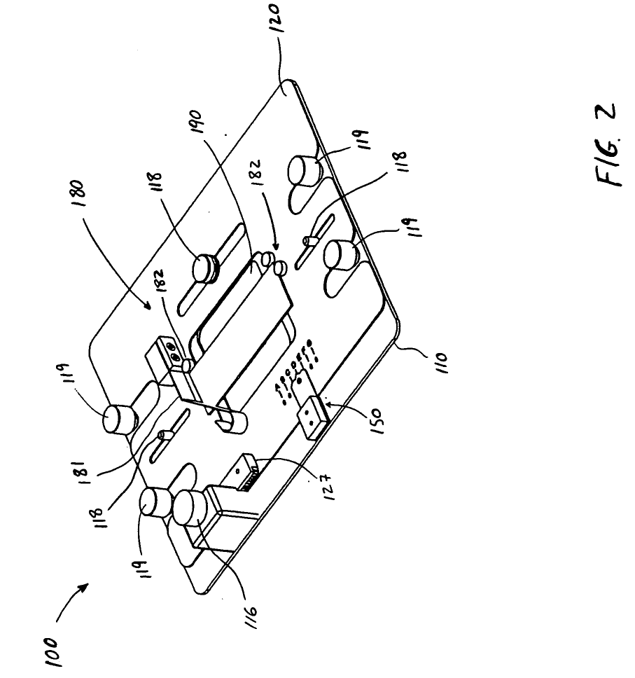

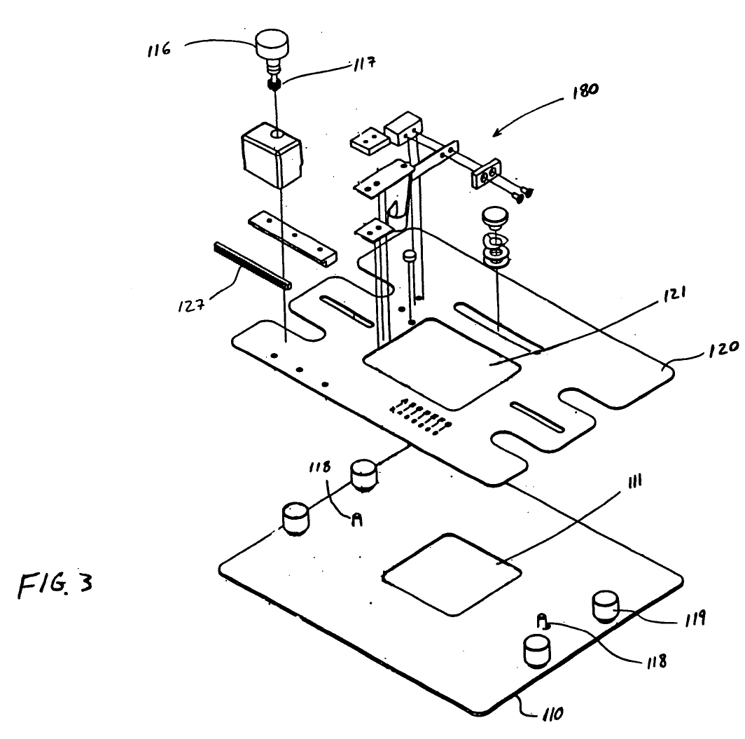

FIG. 2 is a simplified perspective diagram illustrating one embodiment of a substrate holder, and FIG. 3 is a simplified partially exploded diagram illustrating the embodiment of a substrate holder depicted in FIG. 2. Some structural elements and interconnections have been omitted from FIG. 3 for clarity. Holder 100 generally comprises a fixed portion 110 and a movable portion 120 operably coupled to fixed portion 110 and selectively movable relative thereto. Additionally, holder 100 may further comprise a holding or securing mechanism 180 configured and operative to secure a substrate at a predetermined location relative to movable portion 120, in general, and relative to a window 190, in particular. In that regard, each of fixed portion 110 and movable portion 120 may include respective, cooperating apertures (111 and 121, respectively) which define window 190 during use, i.e., when fixed portion 110 and movable portion 120 are coupled and the substrate is secured by securing mechanism 180.

It will be appreciated that the substrate may be embodied in a standard or proprietary laboratory slide such as illustrated in FIG. 1, for example, and may be held firmly and reproducibly, i.e., secured in a predictable location with respect to holder 100 in general, and with respect to window 190 in particular. Selectively moving movable portion 120 may enable a selected area (such as A-E in FIG. 1, for example) to be positioned within the precision travel range 20 of the stage as set forth above with reference to FIG. 1.

Securing mechanism 180 may be incorporated into, attached to, or otherwise integrated with movable portion 120 such that, during use, securing mechanism 180 and the secured substrate may be translated in a predictable manner with movable portion 120 relative to fixed portion 110. Securing mechanism 180 may include one or more springs, set screws, worm screws, or other biasing mechanisms configured and operative to bias the substrate against one or more structures affixed to or otherwise positioned at predetermined locations or reference points on movable portion 120. In the exemplary FIG. 2 embodiment, securing mechanism 180 generally comprises a spring-biased clip 181 operative to engage the substrate at one corner; the opposite corner and one adjacent edge of the substrate may abut or engage one or more structures 182 positioned in an appropriate relationship at the reference points. Accordingly, the substrate can selectively be removed and returned to holder 100 without loss of registration.

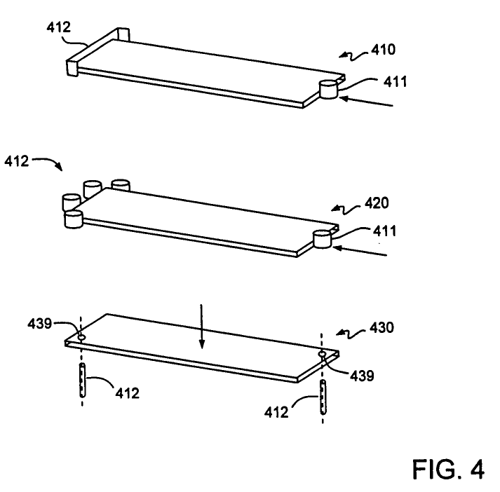

FIG. 4 is a simplified perspective diagram illustrating various embodiments of a securing mechanism. It will be appreciated that some structural elements of the illustrated securing mechanism arrangements have been omitted from FIG. 4 for clarity. The 410 and 420 arrangements may generally employ a biasing element 411 to cause the substrate to abut one or more structures 412 in a secure and predictable manner as described above. In the 410 embodiment, for example, a unitary structure 412 may be fixedly attached to movable portion while a biasing element 411 may be operative to bear against one portion or edge of the substrate, biasing substrate against structure 412. In this instance, biasing element 411 may be spring-loaded, for example, or manually manipulated and locked or otherwise secured (such as with a set screw, for example) in a desired position to provide necessary or suitable biasing force.

In the 420 embodiment, biasing element 411 may be implemented as a screw; in this arrangement, screw revolution may selectively increase, decrease, or release the biasing force exerted on the substrate. As noted generally above, some structural elements have been omitted for clarity. The exemplary 420 embodiment employs multiple securing structures 412 fixedly or movably attached to movable portion in a predetermined or selectively adjustable manner. It will be appreciated that one or more of structures 412 may be moved or relocated relative to movable portion and relative to each other; in accordance with this aspect of the 420 arrangement, structures 412 may be selectively manipulated to accommodate substrates of differing sizes and dimensions.

In the embodiment designated by reference numeral 430, securing structures 412 may generally be implemented as posts or other suitably sized protrusions or projections dimensioned to engage holes or bores 439 disposed at appropriate locations in a proprietary or modified substrate. FIG. 4 is not intended to depict all possible variations for a securing mechanism; those of skill in the art will recognize that other alternatives within the scope and contemplation of the present disclosure may have utility in various applications or system implementations.

It is noted that the embodiments of securing mechanism depicted in FIGS. 2 and 4 may have particular utility when used in conjunction with an inverted microscope, i.e., a microscope configured and operative to obtain images from beneath the substrate or sample stage through window 190, for example. In that regard, structures located at precision reference points may be designed such that, as the objective lens of the inverted microscope makes contact with or presses against the substrate, the substrate will slip off of structures at the reference points in order to avoid damaging the substrate. It will be appreciated that because the substrate is not over constrained by the securing mechanism embodiments set forth herein, various types of damage caused, for example, by bending moments, may be minimized or avoided entirely.

Returning now to FIGS. 2 and 3, in operation, fixed portion 110 may be fixedly attached to or integrated with a precision stage (not shown). In some embodiments, fixed portion 110 may be removably attached to such a stage, or adjustable such that its location relative to, or position on, the stage may be selectively altered; during use, however, relative movement between fixed portion 110 and the stage itself may generally be prevented. In that regard, some embodiments may integrate or otherwise incorporate certain structural features of fixed portion 110 with the stage as noted above. Movable portion 120 may be configured and operative to translate in one or two dimensions relative to fixed portion 110.

Indexed movements in the FIG. 2 embodiment may be accomplished by sliding or translating movable portion 120 relative to fixed portion 110; as noted above, in some embodiments fixed portion 110 may be fixedly attached to the precision stage. Fastening members such as screws, rivets, bolts, or thumbscrews (reference numeral 119 in FIG. 2), for example, or other equivalent or suitable mechanical fastening members, may selectively attach fixed portion 110 to the precision stage at predetermined points. It will be appreciated that the location of such fastening members may be influenced, at least in part, by the structure or constitution of the precision stage to which fixed portion 110 is attached.

In operation, movable portion 120 may be translated along guide pins 118 attached or integrated with fixed portion 110. In some embodiments, pins 118 may include slots, notches, or other equivalent structural elements configured and operative to engage cooperating structures or apertures associated with movable portion 120; accordingly, a pin and aperture arrangement such as depicted in FIGS. 2 and 3 may simultaneously secure movable portion 120 to fixed portion 110 and still allow relative movement of movable portion 120. It will be appreciated that the foregoing functionality may be implemented in various alternative structural arrangements including, but not limited to: bearing systems; rack and pinion or slot and tab structures; wheel and track systems; and other interconnections generally known in the art or developed and operative in accordance with known principles.

As indicated in FIG. 2, fixed portion 110 may comprise a gear mechanism or equivalent device designed and operative to engage a cooperating gear or other suitable structure associated with movable portion 120. In the illustrated rack and pinion arrangement, fixed portion 110 comprises the pinion 117 while movable portion 120 comprises the rack 127. It will be appreciated that worm gears, ball screws, or other equivalent linear actuator mechanisms may be substituted for the rack and pinion assembly depicted in FIGS. 2 and 3 without inventive faculty.

Actuation of the gear mechanism, for example, turning an index selector knob 116, may facilitate selective translation of movable portion 120 relative to fixed portion 110. In that regard, index selector knob 116 may be operatively coupled with a gear, pinion, or other cooperating structure as set forth above such that rotation of index selector knob 116 may result in operation of a linear actuator assembly. Accordingly, precise location of movable portion 120 (and the secured substrate attached thereto) relative to fixed portion 110 may enable accurate positioning of a particular or selected area of the substrate (areas A-E, for example) within the precision travel range 20 of the stage.

While manual activation of the actuator mechanism and indexing system has been described, it will be appreciated that motorized or automated movement of movable portion 120 relative to fixed portion 110 may readily be achieved through addition of one or more electric motors, for example, or other electromechanical elements. In some embodiments, for instance, an electric motor under control of a computer system or other microprocessor or microcontroller may activate the actuator mechanism for precise guidance and control of translation of movable portion 120.

As is apparent from examination of FIG. 2, guide pins 118 or other suitable structures may constrain movable portion 120 such that motion along one axis may be restricted. Alternatively, some embodiments may accommodate two dimensional travel for movable portion 120 relative to fixed portion 110, such as through implementation of one or more additional gear mechanisms and suitable tracks, rails, guides, and interoperable structures such as are generally known in the art.

In some embodiments, the position of movable portion 120 may be indexed, for example, with an index reference or other indicia 150. Accordingly, each particular area A-E of the substrate may be referenced by or otherwise associated with one or more indicia 150 on holder 100. When movable portion 120 is translated such that a particular indicum or other identifier is aligned with a pointer or other cooperating structure, the associated substrate area A-E may be located within the precision travel range 20 of the stage as set forth above with reference to FIG. 1.

The present invention has been illustrated and described in detail with reference to particular embodiments by way of example only, and not by way of limitation. Those of skill in the art will appreciate that various modifications to the exemplary embodiments are within the scope and contemplation of the present disclosure. Therefore, it is intended that the invention be considered as limited only by the scope of the appended claims.

1. A substrate holder comprising:
a fixed portion configured and operative to be attached to a precision stage;
a movable portion operably coupled to said fixed portion and selectively movable relative thereto;
a securing mechanism configured and operative to secure a substrate at a predetermined location relative to said movable portion; and
an actuator mechanism operative to provide movement of said movable portion relative to said fixed portion.

2. The substrate holder of claim 1 wherein said actuator mechanism is operative to translate said movable portion in one dimension relative to said fixed portion.

3. The substrate holder of claim 1 wherein said actuator mechanism is operative to translate said movable portion in two dimensions relative to said fixed portion.

4. The substrate holder of claim 1 wherein each of said fixed portion and said movable portion comprises a respective aperture cooperating to form a window in said holder, and wherein said securing mechanism is operative to secure the substrate at a selected location relative to the window.

5. The substrate holder of claim 1 further comprising an indexed reference system.

6. The substrate holder of claim 5 wherein said indexed reference system comprises:
a pointer; and
a plurality of reference indicia, each corresponding one of said plurality of reference indicia associated with a corresponding area of the substrate.

7. The substrate holder of claim 6 wherein said indexed reference system is operably coupled to said actuator mechanism and wherein selective alignment of ones of said plurality of reference indicia with said pointer translates the corresponding area of the substrate within a precision travel range of the stage.

8. The substrate holder of claim 1 wherein said actuator mechanism is motor driven.

9. A precision travel staging system comprising:
a precision stage;
a substrate holder having a fixed portion configured and operative to be attached to said stage, and a movable portion operably coupled to said fixed portion and selectively movable relative thereto;
a securing mechanism configured and operative to secure a substrate at a predetermined location relative to said movable portion of said substrate holder; and
an actuator mechanism operative to provide movement of said movable portion relative to said fixed portion.

10. The staging system of claim 9 wherein said fixed portion of said substrate holder is integrated with said stage.

11. The staging system of claim 9 wherein a fixed position of said fixed portion of said substrate holder is selectively alterable relative to said stage.

12. The staging system of claim 9 wherein each of said fixed portion and said movable portion comprises a respective aperture cooperating to form a window in said substrate holder, and wherein said securing mechanism is operative to secure the substrate at a selected location relative to the window.

13. The staging system of claim 9 further comprising an indexed reference system.

14. The staging system of claim 13 wherein said indexed reference system comprises:
a pointer; and
a plurality of reference indicia, each corresponding one of said plurality of reference indicia associated with a corresponding area of the substrate.

15. The staging system of claim 14 wherein said indexed reference system is operably coupled to said actuator mechanism and wherein selective alignment of ones of said plurality of reference indicia with said pointer translates the corresponding area of the substrate within a precision travel range of said stage.

16. The staging system of claim 9 wherein said actuator mechanism is motor driven.

17. A method of selectively fastening a substrate to a limited travel staging system; said method comprising:
attaching a fixed portion of a substrate holder to a precision stage;
coupling a movable portion of the substrate holder to the fixed portion; and
securing a substrate in a predetermined position relative to the movable portion.

18. The method of claim 17 wherein said securing comprises utilizing a spring biased element.

19. The method claim 17 further comprising indexing the substrate holder such that each of a plurality of reference indicia on an index is associated with a corresponding area of the substrate.

20. The method of claim 19 wherein said indexing enables selective alignment of ones of said plurality of reference indicia with a pointer to translate a corresponding area of the substrate within a precision travel range of the stage.
